(19) United States
(12) Patent Application Publication
(10) Pub. No.: US 2009/0291845 A1
(43) Pub. Date: Nov. 26, 2009

(54) CONVERSION OF A PRECATALYST TO A CATALYTICALLY ACTIVE SILVER-VANADIUM OXIDE BRONZE

(75) Inventors: Samuel Neto, Dresden (DE); Hartmut Hibst, Schriesheim (DE); Frank Rosowski, Mannheim (DE); Sebastian Storck, Mannheim (DE); Jürgen Zühlke, Speyer (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/158,858

(22) PCT Filed: Dec. 20, 2006
(86) PCT No.: PCT/EP06/70041

§ 371 Date: Aug. 22, 2008

(30) Foreign Application Priority Data
Dec. 21, 2005 (DE) 10 2005 061 382.9

(51) Int. Cl. B01J 21/18

(52) U.S. Cl. 502/184

(57) ABSTRACT

A process is described for converting a precatalyst which comprises an inert support, an organic carbon source and a multimetal oxide comprising silver and vanadium to a gas phase oxidation catalyst which comprises the inert support and a catalytically active silver vanadium oxide bronze, by treating the precatalyst thermally at a temperature of at least 350° C. in a gas atmosphere which comprises less than 10% by volume of oxygen, wherein, before the thermal treatment, the amount of the carbon source in the precatalyst is adjusted to a value below a critical amount The carbon content is reduced by burning-off at a temperature of from 80 to 200° C. in an oxygenous atmosphere with decomposition of a portion of the carbon source. The catalysts obtained serve for the gas phase partial oxidation of aromatic hydrocarbons to aldehydes, carboxylic acids and/or carboxylic anhydrides.

The invention relates to a process for converting a multimetal oxide precatalyst to a gas phase oxidation catalyst with a catalytically active silver vanadium oxide bronze, in particular to a catalyst for gas phase partial oxidation of aromatic hydrocarbons to aldehydes, carboxylic acids and/or carboxylic anhydrides.

A multitude of aldehydes, carboxylic acids and/or carboxylic anhydrides is prepared industrially by the catalytic gas phase oxidation of aromatic hydrocarbons such as benzene, o-, m- or p-xylene, naphthalene, toluene or durene (1,2,4,5-tetramethylbenzene) in fixed bed reactors. Depending on the starting material, for example, benzaldehyde, benzoic acid, maleic anhydride, phthalic anhydride, isophthalic acid, terephthalic acid or pyromellitic anhydride are obtained in this way. To this end, an oxygenous gas, for example air, and the starting material to be oxidized are passed through a multitude of tubes arranged in a reactor, in each of which is disposed a bed of at least one catalyst.

WO 00/27753, WO 01/85337 and WO 2005/012216 describe multimetal oxides comprising silver oxide and vanadium oxide. The thermal treatment converts the multimetal oxides to silver vanadium oxide bronzes which catalyze the partial oxidation of aromatic hydrocarbons, Silver vanadium oxide bronzes are understood to mean silver vanadium oxide compounds with an atomic Ag:V ratio of less than 1. They are generally semiconductive or metallically conductive, oxidic solids which crystallize preferentially in layer or tunnel structures, the vanadium in the [V₂O₅] host lattice being present partly reduced to V(IV). The thermal conversion of the multimetal oxides to silver vanadium oxide bronzes proceeds via a series of reduction and oxidation reactions which are not yet understood in detail.

In practice, the multimetal oxide is applied as a layer to an inert support to obtain a so-called precatalyst. The precatalyst is converted to the active catalyst usually in situ in the oxidation reactor under the conditions of oxidation of aromatic hydrocarbons to aldehydes, carboxylic acids and/or carboxylic anhydrides. In order to prevent thermal damage to the catalyst, the hydrocarbon loading of the gas stream with the hydrocarbon to be oxidized has to be increased slowly from very low values in the course of the in situ conversion, the hotspot temperature in the catalyst bed being controlled. This process is generally drawn out over several days or weeks until the final loading at which productive hydrocarbon oxidation proceeds has been attained.

As detailed, the in situ conversion of the precatalysts is a time-consuming process. Moreover, the precise metering of the small amounts of hydrocarbon at the start of the process is difficult in many cases. It is therefore desirable to suitably pretreat the precatalysts outside the gas phase oxidation reactor, so that the productive gas phase oxidation can be started immediately after the catalyst installation.

WO 00/27753 discloses that the conversion of the precatalyst can also be effected outside the oxidation reactor by thermal treatment at temperatures from above 200 to 650° C., taking into account influencing parameters such as the composition of the gas atmosphere, presence or absence of a binder and type and amount of a binder. The optimal conditions should be determined in a preliminary experiment. The document does not make any more precise statements on these conditions.

It is an object of the invention to specify a convenient process by which the precatalysts can be converted to the active gas phase oxidation catalysts outside the oxidation reactor.

The object is achieved in accordance with the invention by a process for converting a precatalyst which comprises an inert support, an organic carbon source and a multimetal oxide comprising silver and vanadium to a gas phase oxidation catalyst which comprises the inert support and a catalytically active silver vanadium oxide bronze, by treating the precatalyst thermally at a temperature of at least 350° C. in a gas atmosphere which comprises less than 10% by volume of oxygen, wherein, before the thermal treatment, the amount of the carbon source in the precatalyst is adjusted to a (non-zero) value below a critical amount, the critical amount being defined as the amount of carbon source from which reduction to elemental silver occurs in the course of the thermal treatment of the precatalyst.

In the starting multimetal oxide, the vanadium is present in the oxidation state 5 (vanadium (V)); in the silver vanadium oxide bronze, the average vanadium oxidation state is typically from 4.5 to 4.9, in particular from 4.6 to 4.7.

The catalysts obtained by the inventive thermal treatment exhibit sufficient attrition resistance and can be handled, transported and introduced into reaction tubes without any problem.

The gas atmosphere in which the thermal treatment is effected comprises less than 10% by volume, preferably less than 3% by volume and in particular less than 1% by volume of (molecular) oxygen. In general, an inert gas is used, preferably nitrogen, which is essentially oxygen-free. The thermal treatment is appropriately carried out in a gas stream, preferably an inert gas stream.

The thermal treatment can be carried out in all suitable apparatus, for example in tray ovens, rotary sphere ovens, heatable reactors in which a bed of the precatalyst is flowed through by the gas stream, and the like. The thermal treatment is effected at a temperature of at least 350° C., preferably at least 400° C., in particular from 400 to 600° C. Higher temperatures within the range specified lead typically to higher crystallinity and a lower BET surface area of the silver vanadium oxide bronze. The heating rate is not particularly critical; from 1 to 10° C./min are generally suitable. The duration of thermal treatment is generally from 0.5 to 12 hours, preferably from 1 to 5 hours.

The precatalyst comprises an organic carbon source. In the thermal treatment of the precatalyst, the carbon source is suspected to serve as a reducing agent for a partial reduction of the vanadium (V) present in the multimetal oxide to V(IV).

Suitable carbon sources are typical assistants which are used in the preparation of the precatalysts, for example as pore formers or binders. In general, they are (i) compounds which have from 2 to 12 carbon atoms and at least one functional group which is selected from OH, C═O and NH₂; and/or (ii) polymeric compounds which are formed from repeat units which have from 2 to 12 carbon atoms and at least one functional group which is selected from OH, C═O and NH₂. The keto group (C═O) may also be part of a carboxamide, carboxylic acid, carboxylic ester or carboxylic anhydride group. The carbon source is preferably selected from compounds which have from 2 to 6 carbon atoms and at least two functional groups which are each independently selected from OH, C═O and NH₂.

The suitable carbon sources include, for example, ethylene glycol, propylene glycol, glycerol, pentaerythritol, pentoses, hexoses, oxalic acid, ammonium oxalate, malonic acid, maleic acid, fumaric acid, succinic acid, ascorbic acid, benzoic acid, o-, m- and p-toluic acid, phthalic acid, phthalic anhydride, isophthalic acid, terephthalic acid, dimethylformamide, dimethylacetamide, N-methylpyrrolidone.

The suitable carbon sources also include polymers such as polyalkylene glycols, polyalkyleneamines, polysaccharides, polyvinyl alcohol, vinyl acetate/vinyl laurate, vinyl acetate/acrylate, styrene/acrylate, vinyl acetate/maleate or vinyl acetate/ethylene copolymers.

It has been found that the amount of the carbon source in the precatalyst has to be controlled. When the amount of the carbon source is too high, the thermal treatment of the precatalyst does not form silver vanadium oxide bronze, but rather the silver ions present in the multimetal oxide are reduced to elemental silver. While the silver vanadium oxide bronze has a dark green color, the elemental silver deposited on the catalyst appears black. The presence of elemental silver can also be detected in the powder X-ray diffractogram by the occurrence of reflections which are attributable to the cubic silver lattice. Surprisingly, the reduction to elemental silver takes place suddenly from a limiting value in the amount of the carbon source. For the purposes of the present patent application, the limiting value is referred to as “critical amount of carbon source”.

The critical amount depends upon the chemical nature of the carbon source. It can be determined easily by the person skilled in the art in preliminary experiments. For example, a sample amount of a precatalyst with a given content of carbon source can be subjected to the thermal treatment (for example 4 hours at 490° C. in a nitrogen stream), and the resulting catalyst can be analyzed for the occurrence of elemental silver. When there was reduction to elemental silver, the person skilled in the art (in a fresh sample amount of the precatalyst) can lower the carbon content stepwise (in accordance with the process described below) and subject the precatalyst again to a thermal treatment. In this way, the critical amount can be narrowed down rapidly and directly with the aid of a few experiments.

The amount of the carbon source in the precatalyst is preferably adjusted before the thermal treatment to a value of less than 2% by weight (calculated as carbon and based on the weight of the multimetal oxide), for example a value in the range from 0.5 to less than 2% by weight, more preferably to a value of less than or equal to 1.3% by weight. The amount of the carbon source in the precatalyst before the thermal treatment is generally at least 0.1% by weight, usually at least 0.5% by weight, based on the weight of the multimetal oxide.

The carbon content can be determined by combusting a precisely weighed sample of the active composition of the (pre)catalyst in an oxygen stream and detecting the carbon dioxide formed quantitatively, for example by means of an IR cell.

In order to suitably adjust the content of the carbon source, the person skilled in the art can, in the preparation of the precatalyst, consistently select pore formers, binders and further assistants with low carbon content or use carbon-containing assistants only in minor amounts. In general, though, it is essential with regard to reasonable adhesion of the multimetal oxide on the support, a desired pore structure and other factors to use relatively large amounts of carbon-containing assistants in the preparation precatalyst.

In most cases, the precatalyst therefore initially comprises an amount of carbon source which is greater than the critical amount or corresponds to it. Usually, the untreated precatalyst comprises amounts of carbon sources which correspond to from 3 to 10% by weight of carbon based on the weight of the multimetal oxide. The amount of carbon source can be adjusted to a value below the critical amount by heat-treating or burning-off the precatalyst in an oxygenous atmosphere at a temperature of from 80 to 200° C. “Burning-off” shall be understood to mean a reduction in the carbon content, in the course of which a portion of the carbon source evaporates off, sublimes off and/or is decomposed oxidatively to gaseous products such as carbon dioxide.

The burning-off can be carried out in all suitable apparatus, for example those as used for the subsequent thermal treatment of the precatalyst. In order to avoid excessively rapid decomposition of the carbon source with high exothermicity and potential thermal damage to the catalyst, the burning-off preferably comprises at least one heating phase, during which the temperature of the precatalyst is increased at a rate of less than 5° C./min (in particular less than 1.5° C./min), and at least one plateau phase during which the temperature of the precatalyst is kept essentially constant.

The burning-off is effected in an oxygenous atmosphere; the atmosphere comprises preferably at least 5% by volume, e.g. at least 12.5% by volume, and up to 25% by volume of (molecular) oxygen. Air is conveniently used. Particular preference is given to performing the burning-off in an airstream. The burning-off is effected at a temperature of from 80 to 200° C., preferably from 120 to 190° C.

Suitable multimetal oxides, their preparation and their application to inert supports are known per se and are described, for example, in WO 00/27753, WO 01/85337 and WO 2005/012216.

In general, the multimetal oxide has the general formula I

Ag_{a-c}Q_{b}M_{c}V₂O_{d}*e H₂O I

where
a is from 0.3 to 1.9, preferably from 0.5 to 1.0 and more preferably from 0.6 to 0.9;
Q is an element selected from P, As, Sb and/or Bi,
b is from 0 to 0.3, preferably from 0 to 0.1,
M is at least one metal selected from alkali metals and alkaline earth metals, Bi, Tl, Cu, Zn, Cd, Pb, Cr, Au, Al, Fe, Co, Ni, Mo, Nb, Ce, W, Mn, Ta, Pd, Pt, Ru and/or Rh, preferably Nb, Ce, W, Mn and Ta, in particular Ce and Mn, of which Ce is most preferred,
c is from 0 to 0.5, preferably from 0.005 to 0.2, in particular from 0.01 to 0.1; with the proviso that (a-c)≧0.1,
d is a number which is determined by the valency and frequency of the non-oxygen elements in the formula I, and
e is from 0 to 20, preferably from 0 to 5.

The multimetal oxide is preferably present in a crystal structure whose powder X-ray diagram is characterized by reflections at the interplanar spacings d of 15.23±0.6, 12.16±0.4, 10.68±0.3, 3.41±0.04, 3.09±0.04, 3.02±0.04, 2.36±0.04 and 1.80±0.04 Å.

In general, the complete powder X-ray diffraction diagram of the multimetal oxide of the formula I has reflections including the 17 listed in Table 1. Less intense reflections of the powder X-ray diagram of the multimetal oxides of the formula I have not been taken into account in Table 1.

TABLE 1

| Reflection | d | Iᵣₑₗ (%) |
|---|---|---|
| 1 | 15.23 ± 0.6 | 16 |
| 2 | 12.16 ± 0.4 | 11 |
| 3 | 10.68 ± 0.3 | 18 |
| 4 | 5.06 ± 0.06 | 11 |
| 5 | 4.37 ± 0.04 | 23 |
| 6 | 3.86 ± 0.04 | 16 |
| 7 | 3.41 ± 0.04 | 80 |
| 8 | 3.09 ± 0.04 | 61 |
| 9 | 3.02 ± 0.04 | 100 |
| 10 | 2.58 ± 0.04 | 23 |
| 11 | 2.48 ± 0.04 | 24 |
| 12 | 2.42 ± 0.04 | 23 |
| 13 | 2.36 ± 0.04 | 38 |
| 14 | 2.04 ± 0.04 | 26 |
| 15 | 1.93 ± 0.04 | 31 |
| 16 | 1.80 ± 0.04 | 43 |
| 17 | 1.55 ± 0.04 | 36 |

In this application, the X-ray reflections are reported in the form of the interplanar spacings d [Å] independent of the wavelength of the X-radiation used, which can be calculated from the reflection measured by means of the Bragg equation.

The BET specific surface area, measured to DIN 66 131, which is based on the “Recommendations 1984” of the IUPAC International Union of Pure and Applied Chemistry (see Pure & Appl. Chem. 57, 603 (1985)) is generally more than 1 m²/g, preferably from 3 to 250 m²/g, in particular from 10 to 250 m²/g and more preferably from 20 to 80 m²/g.

To prepare the multi metal oxides, a suspension of vanadium pentoxide (V₂O₅) is generally heated with the solution of a silver compound and a solution of a compound of the metal component M and, if appropriate, the solution of a compound of Q. The solvents used for this reaction may be polar organic solvents; the solvent used is preferably water. The silver salt used is preferably silver nitrate.

When used, the element(s) Q from the group of P, As, Sb and/or Bi may be used in elemental form or as oxides or hydroxides. Preference is given to using their partly neutralized or free acids, such as phosphoric acid, hydroarsenic acid, hydroantimonic acid, the ammonium hydrogenphosphates, hydrogenarsenates, hydrogenantimonates and hydrogenbismuthates and the alkali metal hydrogenphosphates, hydrogenarsenates, hydrogenantimonates and hydrogenbismuthates. The element Q used is most preferably phosphorus alone, especially in the form of phosphoric acid, phosphorous acid, hypophosphorous acid, ammonium phosphate or phosphoric esters, and in particular as ammonium dihydrogenphosphate.

The salts of the metal component M used are generally water-soluble salts, for example the perchlorates or carboxylates, in particular the acetates. Preference is given to using the nitrates of the metal component M in question, in particular cerium nitrate or manganese nitrate.

The reaction of the V₂O₅ with the silver compound, the compound of the metal component M and, if appropriate, Q can generally be carried out at room temperature or elevated temperature. In general, the reaction is undertaken at temperatures of from 20 to 375° C., preferably at from 20 to 100° C. and more preferably at from 60 to 100° C. When the temperature of the reaction is above the temperature of the boiling point of the solvent used, the reaction is appropriately performed under the autogenous pressure of the reaction system in a pressure vessel. The reaction conditions are preferably selected such that the reaction can be carried out at atmospheric pressure. The duration of this reaction may, depending on the type of starting materials converted and the temperature conditions employed, be from 10 minutes to 3 days. It is possible to prolong the reaction time of the reaction, for example to 5 days and more. In general, the reaction of the V₂O₅ with the silver compound, the compound of the metal component M to give the multimetal oxide is carried out over a period of from 6 to 24 hours. In the course of the reaction, the orange-red color of the V₂O₅ suspension changes and the new compound forms in the form of a dark brown suspension.

The multimetal oxide thus formed can be isolated from the reaction mixture. The resulting multimetal oxide suspension is particularly advantageously spray-dried. The spray drying is undertaken generally under atmospheric pressure or reduced pressure. The entrance temperature of the drying gas is determined depending upon the pressure employed and solvent used—the drying gas used is generally air, but it is of course also possible to utilize other drying gases such as nitrogen or argon. The entrance temperature of the drying gas in the spray dryer is advantageously selected such that the starting temperature of the drying gas cooled by evaporation of the solution does not exceed 200° C. for a prolonged period. In general, the starting temperature of the drying gas is adjusted to from 50 to 150° C., preferably from 100 to 140° C.

The precatalyst is a precursor of the catalyst which consists of an inert support material and at least one layer applied in coating form thereto, this layer preferably comprising from 30 to 100% by weight, in particular from 50 to 100% by weight, based on the total weight of this layer, of a multimetal oxide of the formula I. The layer more preferably consists entirely of a multimetal oxide of the formula I. When the catalytically active layer, apart from the multimetal oxide of the formula I, also comprises further components, these may, for example, be inert materials such as silicon carbide or steatite, or else other known catalysts for oxidizing aromatic hydrocarbons to aldehydes, carboxylic acids and/or carboxylic anhydrides based on vanadium oxide/anatase. The precatalyst comprises preferably from 5 to 25% by weight, based on the total weight of the precatalyst, of multimetal oxide.

The inert support materials used for the precatalysts and coated catalysts may be virtually all prior art support materials, as find use advantageously in the preparation of coated catalysts for the oxidation of aromatic hydrocarbons to aldehydes, carboxylic acids and/or carboxylic anhydrides, for example quartz (SiO₂), porcelain, magnesium oxide, tin dioxide, silicon carbide, rutile, alumina (Al₂O₃), aluminum silicate, steatite (magnesium silicate), zirconium silicate, cerium silicate or mixtures of these support materials. The support is generally “nonporous”. The term is to be understood in the sense of “nonporous apart from industrially ineffective amounts of pores”, since it is technically unavoidable that a small number of pores be present in the support material which ideally should not comprise any pores. Advantageous support materials to be emphasized are in particular steatite and silicon carbide. The form of the support material is generally not critical for the inventive precatalysts and coated catalysts. For example, it is possible to use catalyst supports in the form of spheres, rings, tablets, spirals, tubes, extrudates or spall. The dimensions of these catalyst supports correspond to those of catalyst supports used typically for preparing coated catalysts for the gas phase partial oxidation of aromatic hydrocarbons. As mentioned, the aforementioned support materials may also be added in powder form to the catalytically active mass of the inventive coated catalysts.

For the coating of the inert support material with the multimetal oxide, known methods can be employed. For example a slurry of the powder of the multimetal oxide obtained after isolation and drying can be sprayed onto the catalyst support in a heated coating drum. It is also possible to use fluidized bed coaters for the application of the multimetal oxide coating to the catalyst support. The suspension of the multimetal oxide may be prepared in water, an organic solvent such as higher alcohols, polyhydric alcohols, e.g. ethylene glycol, 1,4-butanediol or glycerol, dimethylformamide, dimethylacetamide, dimethyl sulfoxide, N-methylpyrrolidone or cyclic ureas such as N,N′-dimethylethyleneurea or N,N′-dimethylpropyleneurea, or in mixtures of these organic solvents with water. It is possible to add organic binders, preferably copolymers, dissolved or advantageously in the form of an aqueous dispersion, in which case binder contents of from 10 to 20% by weight are generally employed, based on the solids content of the suspension or slurry of the inventive multimetal oxide. Suitable binders are, for example, vinyl acetate/vinyl laurate, vinyl acetate/acrylate, styrene/acrylate, vinyl acetatelmaleate or vinyl acetate/ethylene copolymers.

The coated catalysts are used for the partial oxidation of aromatic hydrocarbons to aldehydes, carboxylic acids and/or carboxylic anhydrides, in particular for the gas phase partial oxidation of o-xylene and/or naphthalene to phthalic anhydride or of toluene to benzoic acid and/or benzaldehyde, with a gas comprising molecular oxygen. For this purpose, the catalysts may be used alone or in combination with other catalysts of different activity, for example prior art catalysts based on vanadium oxide/anatase, in which case the different catalyst are generally arranged in separate catalyst beds which may be arranged in one or more fixed catalyst beds in the reactor.

To this end, the coated catalysts or precatalysts are charged into the reaction tubes of a tubular reactor which are thermostatted to the reaction temperature externally, for example by means of a salt melt. The reaction gas is passed through the catalyst bed prepared in this way at temperatures of from 100 to 650° C. and preferably from 250 to 480° C. and at an elevated pressure of generally from 0.1 to 2.5 bar, preferably from 0.3 to 1.5 bar, with a superficial velocity of generally from 750 to 5000 h⁻¹.

The reaction gas supplied to the catalyst is generally obtained by mixing a gas which comprises molecular oxygen and, apart from oxygen, may also comprise suitable reaction moderators and/or diluents such as steam, carbon dioxide and/or nitrogen with the aromatic hydrocarbon to be oxidized, and the gas comprising molecular oxygen may generally comprise from 1 to 100% by volume, preferably from 2 to 50% by volume and more preferably from 10 to 30% by volume of oxygen, from 0 to 30% by volume, preferably from 0 to 20% by volume of steam, and from 0 to 50% by volume, preferably from 0 to 1% by volume of carbon dioxide, remainder nitrogen. To obtain the reaction gas, the gas comprising molecular oxygen is generally supplied with from 30 to 300 g per m³ (STP), preferably with from 70 to 150 g per m³ (STP) of gas of the aromatic hydrocarbon to be oxidized. The gas comprising molecular oxygen is particularly advantageously air.

In a preferred embodiment of the process for partially oxidizing aromatic hydrocarbons to aldehydes, carboxylic acids and/or carboxylic anhydrides, which is found to be particularly advantageous for the preparation of phthalic anhydride from o-xylene and/or naphthalene, the aromatic hydrocarbon is first converted over a bed of the inventive coated catalyst with partial conversion to a reaction mixture. The resulting reaction mixture or a fraction thereof can then be contacted with at least one further catalyst whose catalytically active composition comprises vanadium pentoxide and anatase.

The gaseous stream is preferably passed successively over one bed of a catalyst placed upstream and one bed of a catalyst placed downstream, the bed of the catalyst placed upstream comprising an inventive catalyst and the bed of the catalyst placed downstream comprising at least one catalyst whose catalytically active composition comprises vanadium pentoxide and anatase. In general, the catalytically active composition of the catalyst placed downstream comprises from 1 to 40% by weight of vanadium oxide calculated as V₂O₅, from 60 to 99% by weight of titanium dioxide calculated as TiO₂, up to 1% by weight of a cesium compound calculated as Cs, up to 1% by weight of a phosphorus compound calculated as P and up to 10% by weight of antimony oxide calculated as Sb₂O₃. Advantageously, the bed of the catalyst placed downstream comprises at least two layers of catalysts whose catalytically active composition has different Cs content, the Cs content decreasing in flow direction of the gaseous stream.

The invention is illustrated in detail by the examples and comparative examples which follow.

### EXAMPLES

### Example 1

102 g of V₂O₆ (=0.56 mol) are added with stirring to 7 l of demineralized water at 60° C. The suspension was admixed with an aqueous solution of 4.94 g of CeNO₃·H₂O (=0.011 mol, Aldrich, purity 99%). An aqueous solution of 68 g of AgNO₃ (=0.398 mol) in 1 l of water was added with further stirring to the resulting orange suspension. Subsequently, the temperature of the resulting suspension was increased to 90° C. within 2 hours and the mixture was stirred at this temperature for 24 hours. The resulting dark brown suspension was then cooled and spraydried (entrance temperature (air)=350° C., exit temperature (air)=110° C.). The powder had the composition Ce_{0.02}Ag_{0.71}V₂Oₓ.

The resulting powder had a specific BET surface area of 61 m²/g. A powder X-ray diagram of the resulting powder was recorded with the aid of a Siemens D 5000 diffractometer using Cu—Kα radiation (40 kV, 30 mA). The diffractometer was equipped with an automatic primary and secondary aperture system and a secondary monochromator and scintillation detector. From the powder X-ray diagram, the following interplanar spacings d [Å] with the accompanying relative intensities Iᵣₑₗ [%] were obtained: 15.04 (11.9), 11.99 (8.5), 10.66 (15.1), 5.05 (12.5), 4.35 (23), 3.85 (16.9), 3.41 (62.6), 3.09 (55.1), 3.02 (100), 2.58 (23.8), 2.48 (27.7), 2.42 (25.1), 2.36 (34.2), 2.04 (26.4), 1.93 (33.2), 1.80 (35.1), 1.55 (37.8). The powder was applied to magnesium silicate rings as follows: 350 g of steatite rings with an external diameter of 7 mm, a length of 3 mm and a wall thickness of 1.5 mm were coated in a coating drum at 20° C. with 85 g of the powder and 8.5 g of oxalic acid with addition of 50 ml of a 12.5% by weight aqueous glycerol solution over 20 min and then dried. The weight of the catalytically active mass thus applied, determined on a sample of the resulting precatalyst, was, after heat treatment at 450° C. for one hour, 18% by weight based on the total weight of the finished catalyst. The carbon content was about 4% by weight (based on the active composition).

After the coating, the precatalyst was heated to 140° C. at a heating rate of 0.33° C./min in a forced-air oven under an air atmosphere and kept at this temperature for 4 hours. After this treatment, the carbon fraction in the precatalyst was about 1% by weight (based on the active composition). The precatalyst was then heated to 490° C. at a heating rate of 2° C./min in a rotary-sphere oven (500 ml sphere) under an N₂ atmosphere (1 l (STP)/h.g_{active composition} of N2) and kept at this temperature for 4 hours.

After this treatment, the active composition had a dark green appearance; the carbon content was 0.007% by weight (based on the active composition). By means of X-ray diffractometry, it was shown that it was a crystalline δ-bronze. The BET surface area was 3.9 m²/g, the average vanadium oxidation state 4.67.

After the installation of the catalyst thus prepared into an oxidation reactor together with two downstream layers of V₂O₅/TiO₂ catalysts of different activity, the gas phase oxidation of o-xylene to phthalic anhydride could be started with an initial loading of about 30 g/m³ (STP) of air which could be increased rapidly to about 80 g/m³ (STP).

For comparison, a deinstalled sample of a catalyst prepared in situ had a carbon content of 0.005% by weight (based on the active composition). According to X-ray diffractometry, the deinstalled sample was a crystalline δ-bronze (from the powder X-ray diagram, the following interplanar spacings d [Å] with the accompanying relative intensities Iᵣₑₗ [%] were obtained: 4.85 (9.8), 3.50 (14.8), 3.25 (39.9), 2.93 (100), 2.78 (36.2), 2.55 (35.3), 2.43 (18.6), 1.97 (15.2), 1.95 (28.1), 1.86 (16.5), 1.83 (37.5), 1.52 (23.5)). The BET surface area was 6.7 m²/g, the average vanadium oxidation state 4.63.

### Comparative Example 2

Example 1 was repeated, except that the precatalyst in the first treatment step was heated under air to 100° C. for only 2 hours. The carbon content in the precatalyst was 2.6% by weight. The precatalyst was then kept at 450° C. in a nitrogen stream for 4 hours.

The resulting catalyst was black; in the powder diffractogram, a single intense peak attributable to the cubic lattice of silver was observed. No peaks attributable to the δ-bronze were observed. The BET surface area was 30 m²/g, the average vanadium oxidation state 4.1-4.2 (the catalyst was over-reduced). The carbon content was less than 0.02% by weight.

### Comparative Example 3

Comparative example 2 was repeated, except that the thermal treatment was effected at 450° C. in an air stream.

According to the X-ray diffractogram, the active composition of the resulting catalyst comprised a mixture of β-Ag_{0.33}V₂O₅ and Ag_{1.2}V₃O₈. The average vanadium oxidation state was 4.8.

1-12. (canceled)

13. A process for converting a precatalyst to a gas phase oxidation catalyst wherein the precatalyst comprises an inert supports an organic carbon source and a multimetal oxide comprising silver and vanadium and wherein the gas phase oxidation catalyst comprises the inert support and a catalytically active silver vanadium oxide bronze in which the average vanadium oxidation state is from 4.5 to 4.7, wherein the precatalyst initially comprises an amount of carbon source which is greater than the critical amount or corresponds to it, wherein the process comprises
(iii) adjusting the amount of carbon source by burning-off to a value below the critical amount by treating the precatalyst in an oxygenous atmosphere at a temperature of from 80 to 200° C.; and subsequently
(iv) by treating the precatalyst thermally at a temperature of at least 350° C. in a gas atmosphere which comprises less than 10% by volume of oxygen, the critical amount being defined as the amount of carbon source from which reduction to elemental silver occurs in the course of the thermal treatment of the precatalyst.

14. The process according to claim 13, wherein the thermal treatment is carried out in an inert gas stream.

15. The process according to claim 13, wherein, before the thermal treatment, the amount of the carbon source in the precatalyst is adjusted to a value in the range from 0.5 to less than 2% by weight, calculated as carbon and based on the weight of the multimetal oxide.

16. The process according to claim 15, wherein, before the thermal treatment, the amount of the carbon source in the precatalyst is adjusted to a value of less than or equal to 1.3% by weight.

17. The process according to claim 13, wherein the burning-off comprises at least one heating phase during which the temperature of the precatalyst is increased at a rate of less than 5° C./min and at least one plateau phase during which the temperature of the precatalyst is kept essentially constant.

18. The process according to claim 13, wherein the burning-off is carried out in an air stream.

19. The process according to claim 13, wherein the carbon source is
(v) compounds which have from 1 to 12 carbon atoms and at least one functional group which is selected from OH, C═O and NH₂; or
(vi) polymeric compounds which are formed from repeat units which have from 2 to 12 carbon atoms and at least one functional group which is selected from OH, C═O and NH₂.

20. The process according to claim 19, wherein the carbon source is selected from compounds which have from 2 to 6 carbon atoms and at least two functional groups which are each independently selected from OH, C═O and NH₂.

21. The process according to claim 19, wherein the carbon source is ethylene glycol, propylene glycol, glycerol, pentaerythritol, pentoses, hexoses, oxalic acid, ammonium oxalate, malonic acid, maleic acid, fumaric acid, succinic acid, ascorbic acid, benzoic acid, o-toluic acid, m-toluic acid, p-toluic acid, phthalic acid, phthalic anhydride, isophthalic acid, terephthalic acid, dimethylformamide, dimethylacetamide or N-methylpyrrolidone.

22. The process according to claim 13, wherein the multimetal oxide has the formula I
Ag_{a-c}Q_{b}M_{c}V₂O_{d}*e H₂O
where
a is from0.3 to 1.9,
Q is an element selected from P, As, Sb or Bi or a mixture thereof,
b is from 0 to 0.3,
M is at least one metal selected from alkali metals and alkaline earth metals, Bi, Tl, Cu, Zn, Cd, Pb, Cr, Au, Al, Fe, Co, Ni, Mo, Nb, Ce, W, Mn, Ta, Pd, Pt, Ru or Rh or a mixture thereof,
c is from 0 to 0.5, with the proviso that (a-c)≧0.1,
d is a number which is determined by the valency and frequency of the non-oxygen elements in the formula I, and
e is from 0 to 20.

23. The process according to claim 22, wherein the multimetal oxide is present in a crystal structure whose powder X-ray diagram is characterized by reflections at the interplanar spacings d of 15.23±0.6, 12.16±0.4, 10.68±0.3, 3.41±0.04, 3.09±0.04, 3.02±0.04, 2.36±0.04 and 1.80±0.04 Å.
